(19) United States
(12) Patent Application Publication
(10) Pub. No.: US 2026/0061917 A1
(43) Pub. Date: Mar. 5, 2026

(54) VEHICLE OTTOMAN DEVICE

(71) Applicant: TOYOTA JIDOSHA KABUSHIKI KAISHA, Aichi-ken (JP)

(72) Inventors: Akira KANEKO, Toyota-shi (JP); Daishi TAKATA, Nagoya-shi (JP)

(21) Appl. No.: 19/291,615

(22) Filed: Aug. 6, 2025

(30) Foreign Application Priority Data
Sep. 4, 2024 (JP) 2024-152473

(51) Int. Cl. B60N 2/90; B60N 2/02

(52) U.S. Cl. CPC B60N 2/995; B60N 2/02253

(57) ABSTRACT

A vehicle ottoman device capable of moving a leg rest between a stowed position and a deployed position, the vehicle ottoman device including: a slide mechanism that slides the leg rest in a front-rear direction; and a tilt mechanism that rotates the slide mechanism to change an angle of the slide mechanism with respect to a floor.

### CROSS REFERENCE TO RELATED APPLICATION

This application claims priority to Japanese Patent Application No. 2024-152473 filed on Sep. 4, 2024, which is incorporated herein by reference in its entirety including the specification, claims, drawings, and abstract.

### TECHNICAL FIELD

The present disclosure relates to a vehicle ottoman device, a structure of a vehicle seating device including the vehicle ottoman device, and a control method of the vehicle seating device.

### BACKGROUND

An ottoman device that holds a leg of an occupant seated in a vehicle seat is used. For example, JP2014-004966A discloses an ottoman device that is attached to a lower portion of a seat and that allows a deployment operation of deploying a leg receiver forward of the seat and a retraction operation of retracting the leg receiver in the lower portion of the seat by a four-point linkage. This ottoman device is provided with an interlocking pushing-out mechanism that pushes out the leg receiver forward in conjunction with the deployment operation and retracts the leg receiver in conjunction with the retraction operation (see FIG. 1-4 of JP2014-004966A).

JPH8-308680A discloses a leg rest of a vehicle seat in which a leg receiver can be stored and removed as necessary, and a position and an inclination angle of the leg receiver in a front-rear direction can be selected and held from a plurality of stages according to a use state (see FIG. 2-3 of JPH8-308680A).

In JP2005-247196A, there is disclosed an ottoman device in which when a leg receiver is taken out to a use position in front of a seat, the leg receiver tilts to a position in which a front surface thereof faces upward in conjunction with this movement operation, and when the leg receiver is returned from the use position to a storage position, the leg receiver tilts to an upright state in which an upper surface thereof faces forward in conjunction with this movement operation, and is stored in a seat cushion (see FIGS. 15 to 17 of JP2005-247196A).

In JP2013-248109A, there is disclosed an ottoman device including a link mechanism for moving a leg receiver from a stowed position to a forward operating position, and capable of easily adjusting a posture of the leg receiver near the operating position (see FIGS. 1 to 3 of JP2013-248109A).

In JP2011-250984A, it is disclosed that the calf and the vicinity of ACHILLES tendons of a seated occupant are supported by an ottoman body (see FIGS. 1, 6-11, and 15-17 of JP2011-250984A).

### SUMMARY

Incidentally, the ottoman device of the related art has a configuration in which the leg receiver is deployed and stored by a link mechanism (For example, a four point linkage as described in JP2014-004966A.), and a trajectory of the deployment and storage operation of the leg receiver is uniquely determined. Therefore, it is difficult to dispose the leg receiver at a position where the occupant feels comfortable with respect to occupants of various physical sizes. Further, in the ottoman device (For example, an ottoman device according to JP2014-004966A, JP2005-247196A) of the related art, the leg receiver holds the calf of the occupant, but this position may not be a position where the occupant feels comfortable.

Accordingly, an object of the present disclosure is to allow a leg receiver to be disposed at a position where an occupant feels comfortable with respect to occupants of various physiques.

A vehicle ottoman device according to the present disclosure is capable of moving a leg rest between a stowed position under a seat cushion and a deployed position forward of the seat cushion. The vehicle ottoman device includes: a slide mechanism that slides the leg rest in a front-rear direction; and a tilt mechanism that rotates the slide mechanism to change an angle of the slide mechanism with respect to a floor.

In the vehicle ottoman device according to the present disclosure, by operating the slide mechanism and the tilt mechanism separately, it is possible to freely set the position of the leg rest at the time of deployment and at the time of deployment/retraction operation. Therefore, the leg rest can be disposed at a position where the occupant feels comfortable with respect to occupants of various body sizes.

In the vehicle ottoman device according to the present disclosure, the tilt mechanism may include a tilt bracket rotatably attached to the floor, and a tilt drive unit configured to rotate the tilt bracket. The slide mechanism may include: a guide block attached to the tilt bracket; a rail that is guided by the guide block and slides in the front-rear direction, the rail having a front end to which the leg receiver is attached; and a slide driving unit attached to the guide block to drive the rail in the front-rear direction.

Accordingly, the position of the leg rest can be freely set with a simple configuration.

A vehicle seating device according to an embodiment of the present disclosure includes a vehicle seat, a vehicle ottoman device, and a controller that controls operations of the vehicle seat and the vehicle ottoman device. The vehicle seat includes: a position adjustment mechanism that adjusts a position in the front-rear direction; and a seat tilt mechanism that moves a front portion of the seat cushion up and down. The vehicle ottoman device is capable of moving a leg rest between a stowed position under the seat cushion and a deployed position forward of the seat cushion. The vehicle ottoman device includes: a slide mechanism that slides the leg rest in a front-rear direction; and a tilt mechanism that rotates the slide mechanism to change an angle of the slide mechanism with respect to a floor. The controller includes a processor that performs information processing and a memory that stores control data. The processor is configured to cause the vehicle seat to slide rearward by the position adjustment mechanism, and after sliding the vehicle seat rearward, to raise the front portion of the seat cushion by the seat tilt mechanism, and to raise the leg rest while sliding the leg rest forward by the slide mechanism and the tilt mechanism.

In this way, by operating the vehicle seat and the vehicle ottoman device in conjunction with each other, the position of the leg rest can be held at a position where the occupant feels comfortable at the time of deployment and deployment/retraction operation of the ottoman device.

A vehicle seating device according to an embodiment of the present disclosure, the memory stores a vehicle occupant database storing body information of a vehicle occupant seated in the vehicle seat, the processor is configured to calculate a position of a knee of the vehicle occupant seated in the vehicle seat with reference to the vehicle occupant database, the processor is configured to cause the position adjustment mechanism to slide the vehicle seat rearward such that a position of a rotation center of the slide mechanism in the front-rear direction is a position of the knee of the vehicle occupant in the front-rear direction, the processor is configured to cause the seat tilt mechanism to raise the front portion of the seat cushion and to calculate a path of rotational movement of the vehicle occupant's Achilles tendon about the position of the knee of the vehicle occupant at that time with reference to the vehicle occupant database, the processor is configured to raise the leg rest while sliding the leg rest forward by the slide mechanism and the tilt mechanism so that the leg rest moves along the calculated path.

Accordingly, it is possible to suppress the positional deviation between the receiving surface of the leg rest and the leg of the occupant during the deployment/retraction operation, and it is possible to deploy/retract the leg rest in a state where the occupant feels comfortable. In addition, it is possible to continuously hold the vicinity of the Achilles tendon that the occupant feels comfortable by the leg rest.

A method for controlling a vehicle seating device according to an embodiment of the present disclosure, the vehicle seating device includes a vehicle seat, a position of which can be adjusted in the front-rear direction and a front portion of a seat cushion can be moved up and down, and a vehicle ottoman device capable of moving a leg rest forward-rearward and upward-downward, and the method comprises, after the vehicle seat is slid rearward, the front portion of the seat cushion is raised, and the leg rest is raised while being slid forward.

This allows the position of the leg rest to be maintained at a position that the occupant feels comfortable during deployment and deployment/retraction of the ottoman device.

The present disclosure can allow a leg rest to be placed at a position where the occupant feels comfortable for occupants of various physiques.

### BRIEF DESCRIPTION OF DRAWINGS

FIG. 1 is a side view of a vehicle seating device according to an embodiment;

FIG. 2 is a plan view of the vehicle seating device according to the embodiment;

FIG. 3 is a system diagram of the vehicle seating device according to the embodiment;

FIG. 4 is an occupant database stored in a memory of the vehicle seating device shown in FIG. 3;

FIG. 5 is a flowchart showing the operation of the vehicle seating device according to the embodiment;

FIG. 6 is a side view showing the operation of the vehicle seating device according to the embodiment, showing a state in which the vehicle ottoman device is in a retracted position.

FIG. 7 is a side view showing the operation of the vehicle seating device of the embodiment, showing a state in which the vehicle seat slides rearward.

FIG. 8 is a side view showing the operation of the vehicle seating device of the embodiment, showing a state in which the vehicle seat slides rearward and the leg rest of the vehicle ottoman device holds the vicinity of the Achilles tendon of the occupant.

FIG. 9 is a side view showing the operation of the vehicle seating device of the embodiment, showing a state in which the leg rest of the vehicle ottoman device rises while sliding forward together with the tilt operation of the vehicle seat.

FIG. 10 is a side view illustrating the operation of the vehicle seating device according to the embodiment, and is a view illustrating a state in which the tilt operation of the vehicle seat is ended and the leg rest of the vehicle ottoman device is in the deployed position.

### DESCRIPTION OF EMBODIMENTS

Hereinafter, a vehicle seating device 100 according to an embodiment will be described with reference to the drawings. In the following description, the vehicle seating device 100 is attached to the floor 11 of the vehicle so that the occupant 70 faces the front of the vehicle. In this case, the front side and the rear side of the vehicle seating device 100 are the front side and the rear side of the vehicle, respectively. Reference numerals FR, UP, and RH in the drawings indicate a front side, an upper side, and a right side of the vehicle seating device 100, respectively. The opposite directions of FR, UP, and RH indicate the rear side, the lower side, and the left side, respectively. Hereinafter, in the case of simply using the front-rear direction, the left-right direction, and the up-down direction, the front-rear direction, the left-right direction, and the up-down direction of the vehicle seating device 100 are indicated unless otherwise specified.

The vehicle seating device 100 may be attached to the floor 11 of the vehicle such that the occupant 70 faces the rear of the vehicle. In this case, the front side and the rear side of the vehicle seating device 100 are the rear side and the front side of the vehicle, respectively.

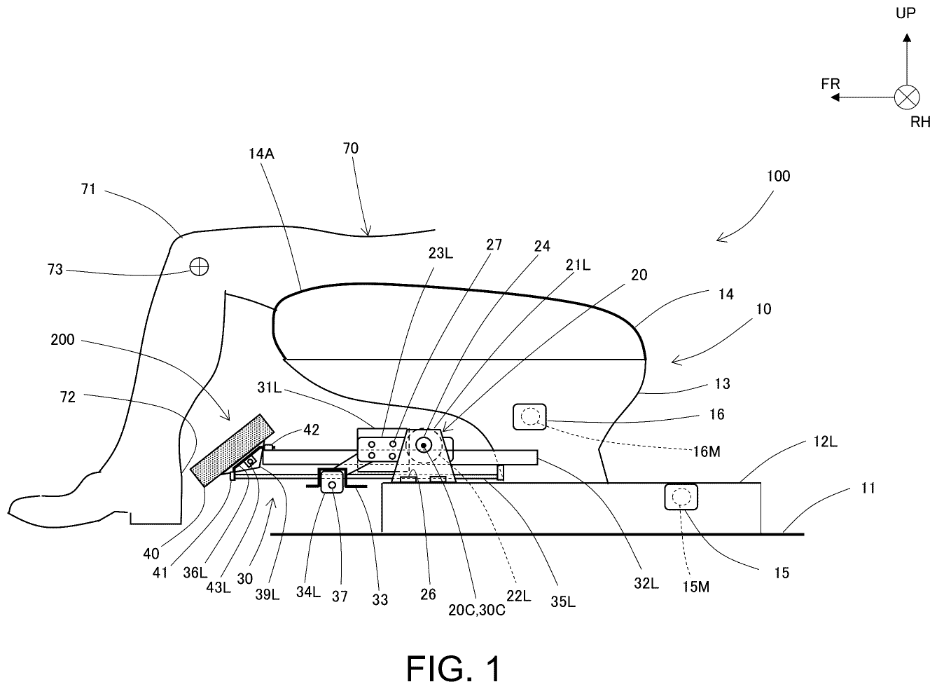

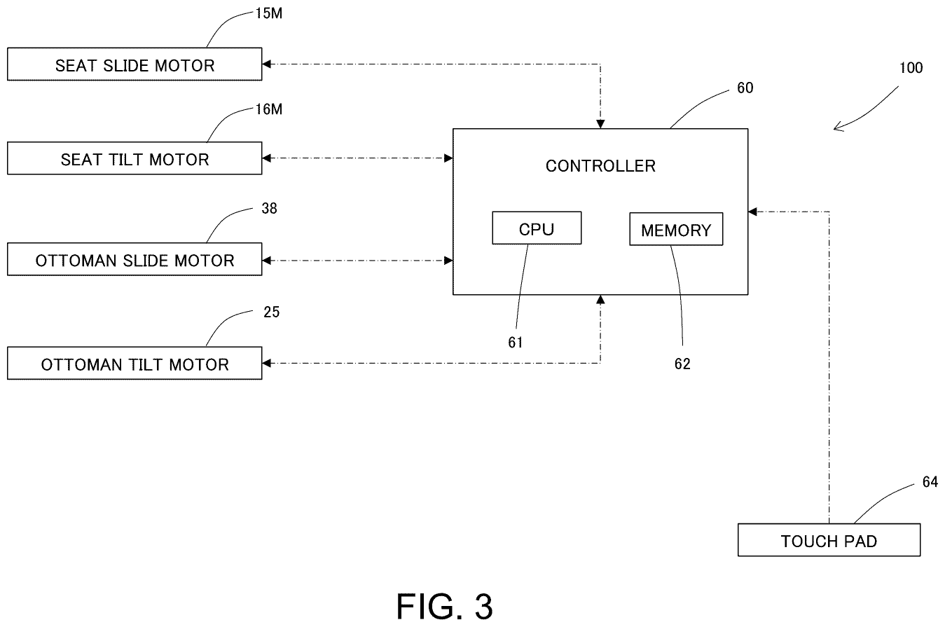

As illustrated in FIGS. 1 to 3, the vehicle seating device 100 includes a vehicle seat 10, a vehicle ottoman device 200, and a controller 60 (see FIG. 3).

The vehicle seat 10 includes left and right seat rails 12L and 12R, a frame 13, a seat cushion 14, a position adjustment mechanism 15, and a seat tilt mechanism 16.

The left and right seat rails 12L and 12R are longitudinal members that are attached to the floor 11 of the vehicle and extend in the front-rear direction. The frame 13 is mounted on the left and right seat rails 12L and 12R so as to be slidable in the front-rear direction. The seat cushion 14 is attached to an upper portion of the frame 13. The position adjustment mechanism 15 is provided between the left and right seat rails 12L and 12R, and moves the frame 13 in the front-rear direction. The position adjustment mechanism 15 may include a seat slide motor 15M, a worm gear, a screw, and the like (not shown). The seat tilt mechanism 16 is attached to the frame 13, and moves the front portion 14A of the seat cushion 14 up and down. The seat tilt mechanism 16 may include a seat tilt motor 16M, a worm gear, a screw, and the like (not shown).

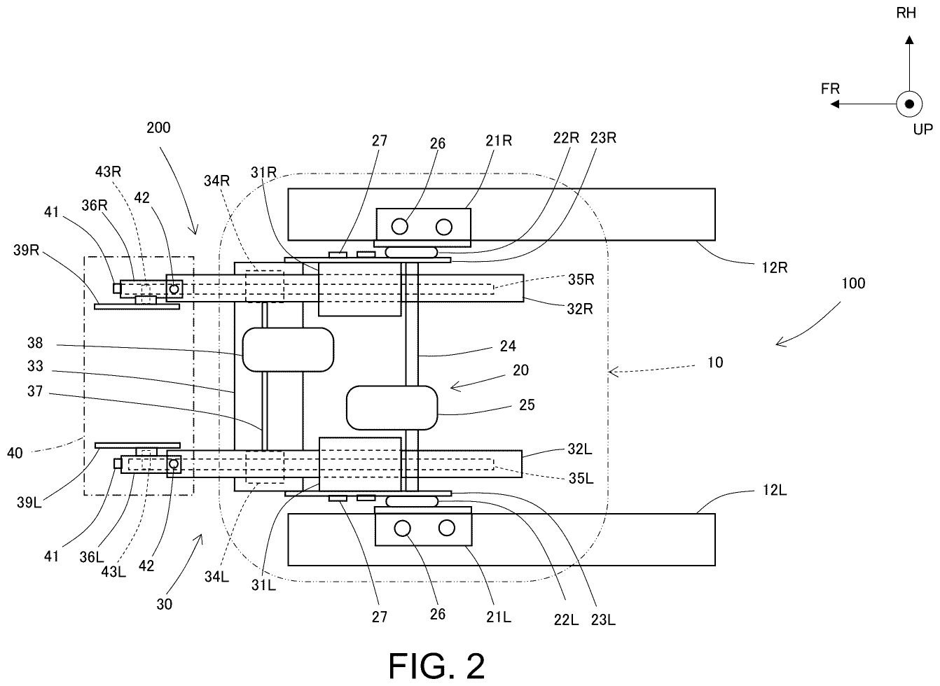

The vehicle ottoman device 200 includes a tilt mechanism 20 and a slide mechanism 30. As shown in FIGS. 1 and 2, the tilt mechanism 20 includes left and right bases 21L and 21R, a rod 24, left and right round gears 22L and 22R, left and right tilt brackets 23L and 23R, and an ottoman tilt motor 25.

The left and right bases 21L and 21R are fixed on the left and right seat rails 12L and 12R by bolts 26. Both ends of the rod 24 are rotatably supported by the left and right bases 21L and 21R. The left and right round gears 22L and 22R include tilt gears (not shown) that rotate around the rod 24 by engaging with gears (not shown) provided at left and right end portions of the rod 24. The left and right tilt brackets 23L and 23R are connected to tilt gears in the left and right round gears 22L and 22R, and are rotatable about the rod 24. The center of the rod 24 is the rotation center 20C of the tilt mechanism 20. The ottoman tilt motor 25 is fixed to the floor 11 and rotationally drives the rod 24. Therefore, the ottoman tilt motor 25, the rod 24, and the left and right round gears 22L and 22R constitute a tilt driving unit.

The slide mechanism 30 includes left and right guide blocks 31L and 31R, left and right rails 32L and 32R, a cross frame 33, left and right gear boxes 34L and 34R, left and right screws 35L and 35R, left and right connecting plates 36L and 36R, a shaft 37, an ottoman slide motor 38, left and right leg rest brackets 39L and 39R, and a leg rest 40.

The left and right guide blocks 31L and 31R are fixed to the left and right tilt brackets 23L and 23R by a plurality of bolts 27. The left and right rails 32L and 32R penetrate the left and right guide blocks 31L and 31R in the front-rear direction, and slide in the front-rear direction while being guided by the left and right guide blocks 31L and 31R. The left and right screws 35L and 35R are disposed below the left and right rails 32L and 32R in parallel with the left and right rails 32L and 32R. Front ends of the left and right screws 35L and 35R are fixed to front end portions of the left and right rails 32L and 32R by left and right connecting plates 36L and 36R and bolts 41 and 42. Rear ends of the left and right screws 35L and 35R are connected to rear end portions of the left and right rails 32L and 32R.

The cross frame 33 is a hat-shaped cross-sectional member that connects the left and right tilt brackets 23L and 23R in the left-right direction. The left and right gear boxes 34L and 34R are attached to left and right end portions of the cross frame 33. The shaft 37 is rotatably supported by the left and right gear boxes 34L and 34R. Left and right worm gears (not shown) that engage with the left and right screws 35L and 35R are provided at left and right end portions of the shaft 37. The left and right worm gears are housed in the left and right gear boxes 34L and 34R. The ottoman slide motor 38 is mounted on the cross frame 33 to rotationally drive the shaft 37.

Accordingly, the gear boxes 34L and 34R, the left and right screws 35L and 35R, the ottoman slide motor 38, and the shaft 37 constitute a slide driving unit. The slide driving unit is connected to the left and right guide blocks 31L and 31R via the cross frame 33 and the left and right tilt brackets 23L and 23R. Therefore, the slide driving unit is attached to the left and right guide blocks 31L and 31R to drive the left and right rails 32L and 32R in the front-rear direction.

The left and right leg rest brackets 39L and 39R are rotatably attached to the left and right connecting plates 36L and 36R by pins 43L and 43R, respectively. The leg rest 40 is attached to upper portions of the left and right leg rest brackets 39L and 39R.

As shown in FIG. 3, the controller 60 is a computer including a CPU 61, which is a processor that performs information processing, and a memory 62 that stores a control program and control data. The seat slide motor 15M, the seat tilt motor 16M, the ottoman slide motor 38, and the ottoman tilt motor 25 are connected to the controller 60 and operate in accordance with a command from the controller 60. The seat slide motor 15M, the seat tilt motor 16M, and the ottoman slide motor 38 include resolvers (not shown) that detect the rotational angle position of the motor shaft, and the output signals of the resolvers are input to the controller 60. An operation signal of the touch pad 64 operated by the occupant 70 seated in the vehicle seat 10 is input to the controller 60. The controller 60 controls the seat slide motor 15M, the seat tilt motor 16M, and the ottoman slide motor 38 based on the output signal of each resolver and the operation signal of the touch pad 64, and adjusts the operations of the vehicle seat 10 and the vehicle ottoman device 200.

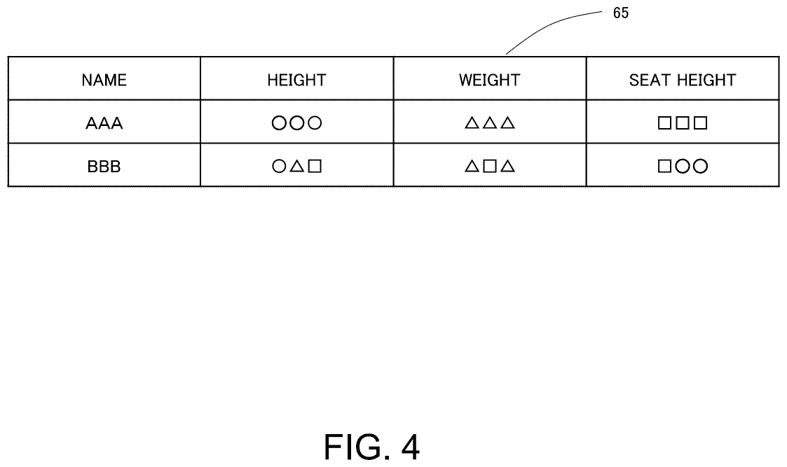

The memory 62 of the controller 60 stores an occupant database 65 as shown in FIG. 4. The occupant database 65 stores the name and the body information of the occupant 70 seated on the vehicle seat 10 in association with each other. The physical information may be, for example, the height, weight, and seat height of the occupant 70 as illustrated in FIG. 4. As will be described later, the physical information is not limited to this as long as the physical information can calculate the position of the knee 71 of the occupant 70 and the path of the rotational movement of the Achilles tendon 72 about the rotation center position 73 of the knee 71.

Next, a basic tilt operation and a basic slide operation of the vehicle ottoman device 200 will be described. First, the tilt operation will be described. When the rod 24 is rotated by the ottoman tilt motor 25, the tilt gears of the left and right round gears 22L and 22R are rotated, whereby the left and right tilt brackets 23L and 23R are rotated around the center of the rod 24. As a result, the front portions of the left and right tilt brackets 23L and 23R rotate in the vertical direction.

Then, the guide blocks 31L and 31R fixed to the left and right tilt brackets 23L and 23R by the bolts 27 rotate in the vertical direction, and the front portions of the left and right rails 32L and 32R rotate in the vertical direction accordingly. The leg rest 40 attached to the front ends of the left and right rails 32L and 32R via the left and right leg rest brackets 39L and 39R rotates in the vertical direction. In this way, the entire slide mechanism 30 rotates about the center of the rod 24. Therefore, the center of the rod 24 is the rotation center 20C of the tilt mechanism 20 and the rotation center 30C of the slide mechanism 30. Further, the tilt mechanism 20 changes the angle of the slide mechanism 30 with respect to the floor 11.

Next, the sliding operation will be described. When the shaft 37 is rotated by the ottoman slide motor 38, the left and right worm gears accommodated in the gear boxes 34L and 34R are rotated. Then, the left and right screws 35L and 35R engaged with the left and right worm gears move in the front-rear direction. When the left and right screws 35L and 35R move in the front-rear direction, the left and right rails 32L and 32R connected in parallel to the left and right screws 35L and 35R move in the front-rear direction. The leg rest 40 attached to the front ends of the left and right rails 32L and 32R via the left and right leg rest brackets 39L and 39R slides in the front-rear direction.

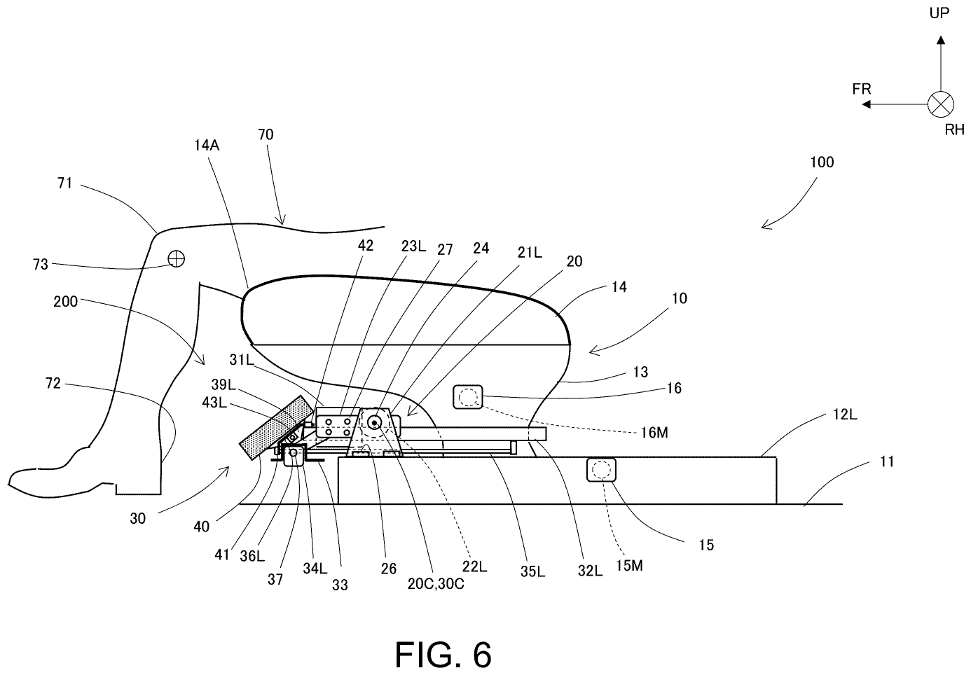

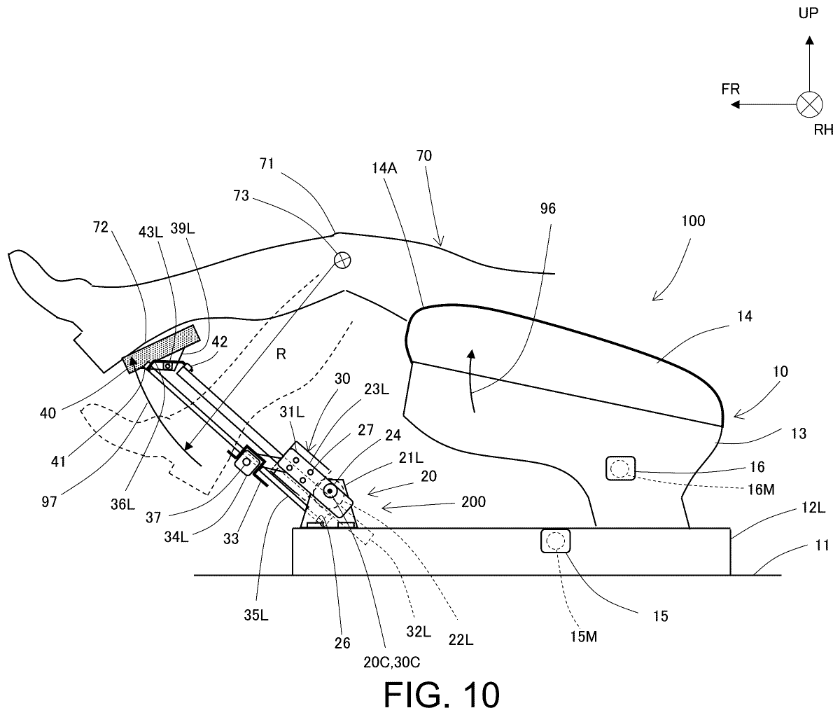

The tilt operation and the slide operation can be separately performed by the occupant 70 operating the tilt angle and the slide amount with the touch pad 64. Thus, the vehicle ottoman device 200 can freely set the position of the leg rest 40 at the time of deployment as shown in FIG. 10. Further, the position of the leg rest 40 during the deployment operation as shown in FIGS. 6 to 10 can be freely set. Therefore, the vehicle ottoman device 200 can dispose the leg rest 40 at a position where the occupant 70 feels comfortable with respect to the occupant 70 of various body sizes.

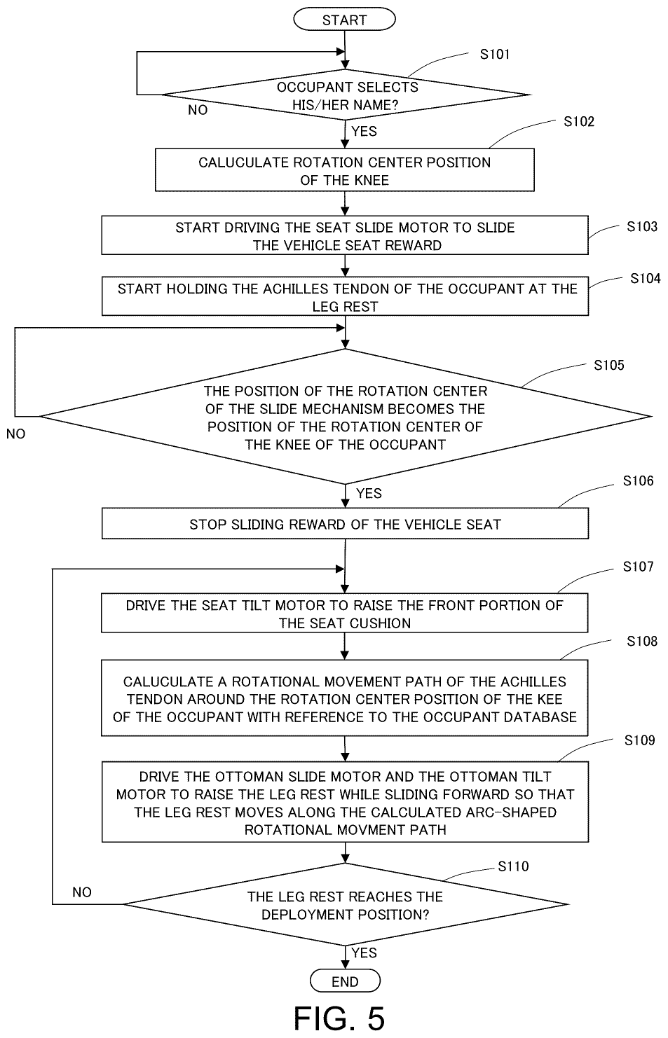

Next, an automatic deployment operation of the vehicle ottoman device 200 in conjunction with the seat tilt operation of the vehicle seat 10 will be described with reference to FIGS. 5 to 10. As shown in FIG. 6, in the initial state, the left and right rails 32L and 32R of the vehicle ottoman device 200 are parallel to the floor 11 and move rearward. As a result, the leg rest 40 of the vehicle ottoman device 200 is stored in the storage position under the seat cushion 14.

As illustrated in step S101 of FIG. 5, when the occupant 70 seated in the vehicle seat 10 operates the touch pad 64 to select automatic deployment of the vehicle ottoman device 200, the CPU 61 of the controller 60 displays the name of the occupant 70 registered in the touch pad 64 with reference to the occupant database 65. Then, the vehicle stands by until the occupant 70 seated on the vehicle seat 10 selects his/her name. When the occupant 70 selects the name, the rotation center position 73 of the knee 71 of the occupant 70 is calculated with reference to the occupant database 65 in step S102 of FIG. 5. In this calculation, for example, the sinking amount of the seat cushion 14 may be calculated based on the body weight, and the position of the buttocks of the occupant 70 may be calculated from the calculated sinking amount and the height of the seat cushion 14 of the vehicle seat 10. Then, the position of the knee 71 and the rotation center position 73 of the knee 71 may be calculated based on the height, the seat height, and the position of the buttocks.

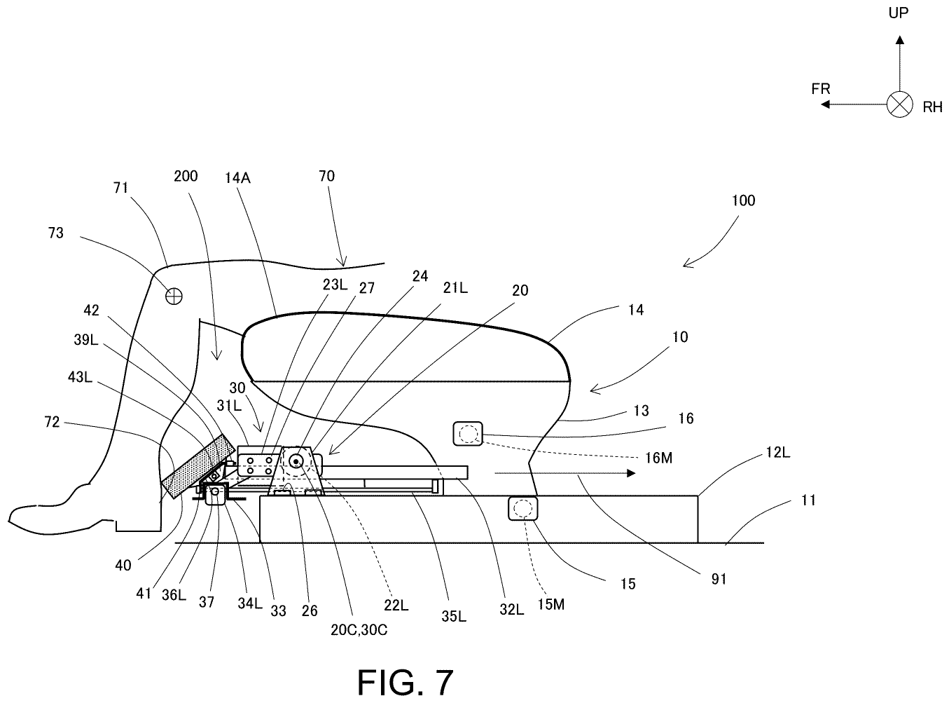

Next, the CPU 61 of the controller 60 proceeds to step S103 of FIG. 5, and drives the seat slide motor 15M to slide the vehicle seat 10 rearward as indicated by an arrow 91 in FIG. 7 from the initial state shown in FIG. 6.

Then, as shown in step S104 of FIG. 5 and FIG. 7, when the leg rest 40 comes in the vicinity of the Achilles tendon 72 of the occupant 70, the CPU 61 of the controller 60 lowers the rearward movement speed of the vehicle seat 10, and starts holding the Achilles tendon 72 of the occupant 70 at the leg rest 40.

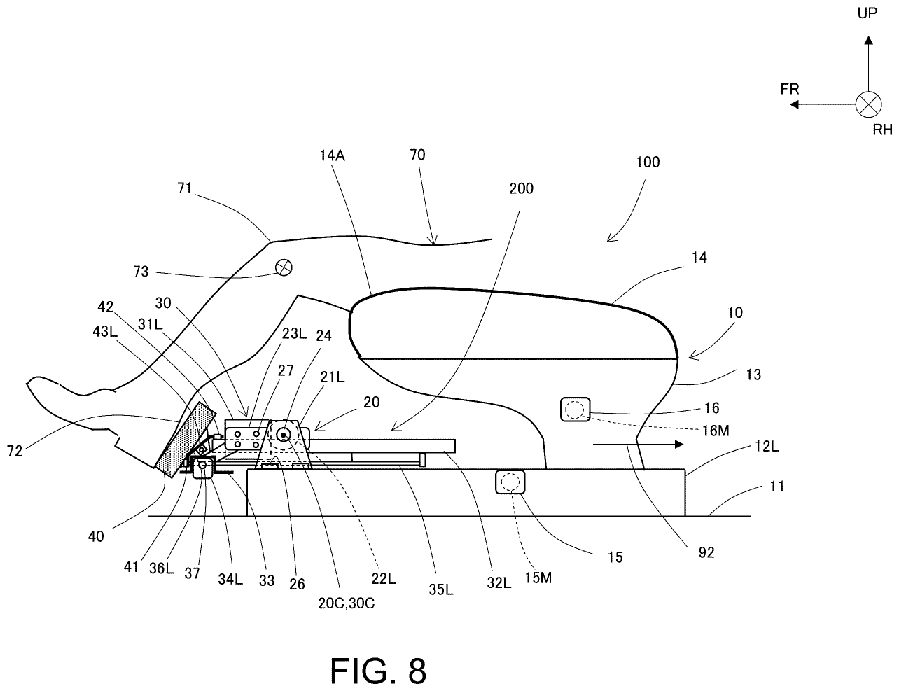

Next, the CPU 61 of the controller 60 moves the vehicle seat 10 rearward until the front-rear direction position of the rotation center 30C of the slide mechanism 30 becomes the front-rear direction position of the rotation center position 73 of the knee 71 of the occupant 70 as shown in step S105 of FIG. 5 and the arrow 92 in FIG. 8. If YES is determined in step S105 of FIG. 5, the controller 60 stops the rearward sliding of the vehicle seat 10 in step S106 of FIG. 5, and proceeds to step S107 of FIG. 5.

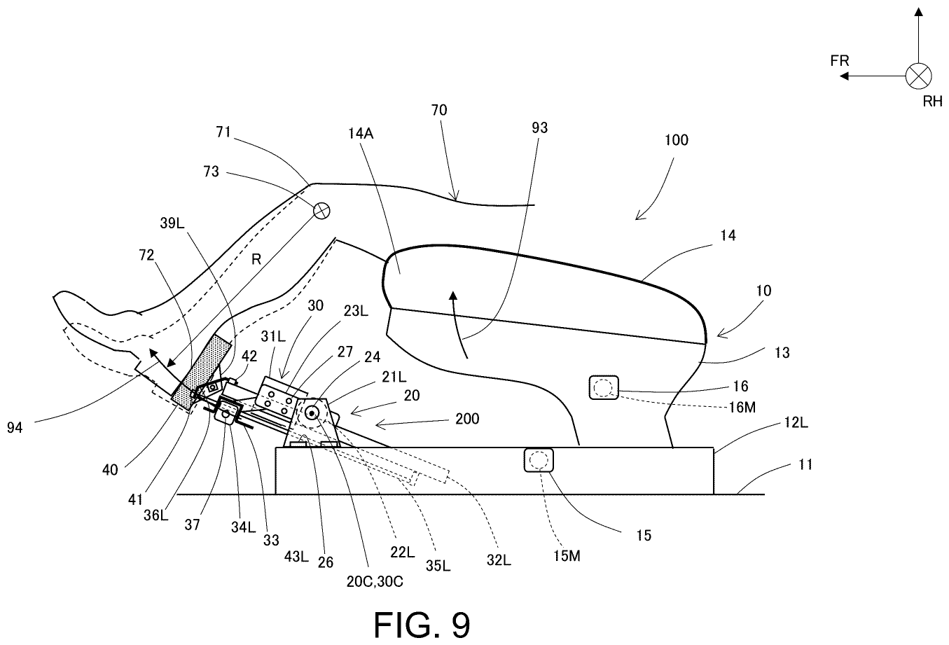

Next, in step S107 of FIG. 5, the CPU 61 of the controller 60 drives the seat tilt motor 16M to raise the front portion 14A of the seat cushion 14 as indicated by an arrow 93 in FIG. 9. Then, as shown in step S108 of FIG. 5, the CPU 61 of the controller 60 calculates a rotational movement path 94 of the Achilles tendon 72 around the rotation center position 73 of the knee 71 of the occupant 70 with reference to the occupant database 65. As shown in FIG. 9, the rotational movement path 94 is an arc having a radius R around the rotation center position 73 of the knee 71. Here, the radius R is a distance from the rotation center position 73 to the Achilles tendon 72.

Then, the CPU 61 of the controller 60 proceeds to step S109 of FIG. 5 and drives the ottoman slide motor 38 and the ottoman tilt motor 25 to raise the leg rest 40 while sliding forward so that the leg rest 40 moves along the calculated arc-shaped rotational movement path 94. As a result, the lower limb of the occupant 70 moves from a position indicated by a broken line in FIG. 9 before the ottoman tilt motor 25 starts driving to a position indicated by a solid line in FIG. 9.

When the front portion 14A of the seat cushion 14 is raised, the rotation center position 73 of the knee 71 of the occupant 70 moves upward. Therefore, when the CPU 61 of the controller 60 raises the leg rest 40 while sliding it slightly forward in step S109 of FIG. 5 and determines NO in step S110 of FIG. 5, the process returns to step S107 of FIG. 5 and repeats step S107 to step S108. In this way, the CPU 61 of the controller 60 calculates the rotational movement path 97 of the Achilles tendon 72 centered on the position of the rotation center position 73 of the knee 71 of the occupant 70 while raising the front portion 14A of the seat cushion 14 as indicated by the arrow 96 in FIG. 10, and slides the leg rest 40 forward along the calculated rotational movement path 97. Accordingly, the lower limb of the occupant 70 moves from a position indicated by a broken line in FIG. 10 to a position indicated by a solid line in FIG. 10.

The CPU 61 of the controller 60 detects the position of the leg rest 40 based on the rotational angle positions of the motor shafts input from the resolvers of the ottoman slide motor 38 and the ottoman tilt motor 25. When the position of the leg rest 40 reaches the predetermined deployment position as shown in FIG. 10 in step S110 of FIG. 5, YES is determined in step S110 of FIG. 5, and the automatic deployment operation of the vehicle ottoman device 200 is ended.

As described above, in the vehicle seating device 100, when the vehicle ottoman device 200 is automatically deployed, the vehicle seat 10 and the vehicle ottoman device 200 are operated in conjunction with each other, and after the vehicle seat 10 is slid rearward, the front portion 14A of the seat cushion 14 is lifted, and the leg rest 40 is lifted while being slid forward. Accordingly, the position of the leg rest 40 can be held at a position where the occupant 70 feels comfortable at the time of deployment and deployment/retraction operation of the vehicle ottoman device 200. In addition, the vehicle seating device 100 for a vehicle can suppress positional deviation between the receiving surface of the leg rest 40 and the leg of the occupant 70 during the deployment/retraction operation, and can deploy/retract the leg rest 40 in a state where the occupant 70 feels comfortable. In addition, the leg rest 40 can continuously hold the vicinity of the Achilles tendon 72 that the occupant 70 feels comfortable.

As described above, the vehicle ottoman device 200 can be operated separately by the occupant 70 operating the tilt angle and the slide amount with the touch pad 64. Thus, the vehicle ottoman device 200 can freely set the position of the leg rest 40 at the time of deployment or at the time of deployment/retraction operation. Therefore, the vehicle ottoman device 200 can dispose the leg rest 40 at a position where the occupant 70 feels comfortable with respect to the occupant 70 of various body sizes.

1. A vehicle ottoman device comprising:
a leg rest movable between a stowed position under a seat cushion and a deployed position forward of the seat cushion;
a slide mechanism that slides the leg rest in the front-rear direction; and
a tilt mechanism that rotates the slide mechanism to change an angle of the slide mechanism with respect to a floor.

2. The vehicle ottoman device according to claim 1, wherein
the tilt mechanism includes:
a tilt bracket rotatably attached to the floor; and
a tilt drive unit that rotates the tilt bracket, and
the slide mechanism includes:
a guide block attached to the tilt bracket;
a rail to which the leg rest is attached at a front end and which is guided by the guide block and slides in the front-rear direction; and
a slide driving unit attached to the guide block to drive the rail in the front-rear direction.

3. A vehicle seating device comprising:
a vehicle seat;
a vehicle ottoman device; and
a controller configured to control an operation of the vehicle seat and the vehicle ottoman device,
wherein the vehicle seat includes:
a position adjustment mechanism that adjusts a position of the vehicle seat in the front-rear direction; and,
a seat tilt mechanism that moves a front portion of a seat cushion of the vehicle seat up and down, and
the vehicle ottoman device includes:
a leg rest movable between a stowed position under the seat cushion and a deployed position forward of the seat cushion;
a slide mechanism that slides the leg rest in the front-rear direction; and
a tilt mechanism that rotates the slide mechanism to change an angle of the slide mechanism with respect to a floor,
the controller includes a processor that performs information processing and a memory that stores control data,
the processor is configured
to cause the vehicle seat to slide rearward by the position adjustment mechanism, and
after sliding the vehicle seat rearward, to raise the front portion of the seat cushion by the seat tilt mechanism, and to raise the leg rest while sliding the leg rest forward by the slide mechanism and the tilt mechanism.

4. The vehicle seating device according to claim 3, wherein
the memory stores a vehicle occupant database storing body information of a vehicle occupant seated in the vehicle seat,
the processor is configured to calculate a position of a knee of the vehicle occupant seated in the vehicle seat with reference to the vehicle occupant database,
the processor is configured to cause the position adjustment mechanism to slide the vehicle seat rearward such that a position of a rotation center of the slide mechanism in the front-rear direction is a position of the knee of the vehicle occupant in the front-rear direction,
the processor is configured to cause the seat tilt mechanism to raise the front portion of the seat cushion and to calculate a path of rotational movement of the vehicle occupant's Achilles tendon about the position of the knee of the vehicle occupant at that time with reference to the vehicle occupant database,
the processor is configured to raise the leg rest while sliding the leg rest forward by the slide mechanism and the tilt mechanism so that the leg rest moves along the calculated path.

5. A method for controlling a vehicle seating device, wherein,
the vehicle seating device comprises:
a vehicle seat, a position of which can be adjusted in the front-rear direction and a front portion of a seat cushion can be moved up and down, and
a vehicle ottoman device capable of moving a leg rest forward-rearward and upward-downward, and
the method comprises,
after the vehicle seat is slid rearward, the front portion of the seat cushion is raised, and the leg rest is raised while being slid forward.
